(19) United States
(12) Patent Application Publication
(10) Pub. No.: US 2025/0263135 A1
(43) Pub. Date: Aug. 21, 2025

(54) END OF TRAILER FAIRING WITH FLEXIBLE ATTACHMENT MEMBER

(71) Applicant: Trailer Aerodynamics LLC, Chicago, IL (US)

(72) Inventors: Justin Kane MORGAN, Anderson, SC (US); Tara SANZONE, Greenville, SC (US); Amarraj ALKOD, Greenville, SC (US)

(73) Assignee: Trailer Aerodynamics LLC, Chicago, IL (US)

(21) Appl. No.: 19/057,184

(22) Filed: Feb. 19, 2025

Related U.S. Application Data
(60) Provisional application No. 63/555,540, filed on Feb. 20, 2024.

(51) Int. Cl. B62D 35/00

(52) U.S. Cl. CPC B62D 35/001

(57) ABSTRACT

A fairing includes a right end, a left end, a main portion extend therebetween, a support member, and a flexible attachment member. The main portion defines a fairing interior and includes a right end wall and a left end wall. The right end wall connects to the right end, and the left ed wall connects to the left end. The support member is within the fairing interior and extends between the right end wall and the left end wall. The flexible attachment member is threaded through a passage of the support member and is connected to and extends between the right end wall and the left end wall.

### CROSS REFERENCE TO RELATED APPLICATION(S)

This disclosure claims the benefit of and priority to U.S. Provisional Patent Application No. 63/555,540, filed on Feb. 20, 2024, which is hereby incorporated by reference in its entirety.

### TECHNICAL FIELD

The subject matter of the present disclosure relates to an end of the trailer fairing that improves aerodynamic performance of the trailer. More particularly, the present disclosure involves a fairing that features a flexible attachment member that functions to retain a main portion of the trailer fairing to the trailer.

### BACKGROUND

Trailers towed by trucks and similar apparatuses for transporting cargo can be large, unwieldy, and include geometries which invite inefficiencies during travel. One aspect of these inefficiencies concerns the aerodynamics of the trailer. In an effort to improve trailer aerodynamics, trailers have been built, supplemented, or retro-fitted with trailer skirts (or side skirts), devices affixed to the underside which limit air circulating in the empty space between the trailer's axles. By reducing the amount of airflow in this space, drag caused by turbulence is reduced and permits the trailer to be towed more efficiently, increasing the gas mileage and performance of the vehicle and its cargo. Other ways of improving aerodynamic performance of the trailer involves the provision of fairings to the end of the trailer. The fairings modify the airflow around or off of the end of the trailer to reduce drag. It is known to produce fairings that have a curved outer surface that extend from the leading edge of the fairing to the tailing edge of the fairing. These curved fairings change the airflow about the end of the trailer to reduce dragging force. These fairings may be mounted to the sides of the trailer, or to the top surface of the trailer at the back end of the trailer.

Trailer fairings on the market today may incorporate adhesive or tape as a primary mechanism of attachment to secure a front end of the fairing to the trailer. However, if the adhesive or tape fails, air may flow underneath the front end of the fairing, lifting a main portion of the fairing and causing the main portion to tear away from right and left ends of the fairing that are secured to the trailer.

### SUMMARY

In some aspects, a fairing is configured to be mounted to a surface of a trailer. The fairing may include a first end, a second end, a main portion extending between the first end and the second end, and a support member. The main portion may define a fairing interior and may include a first end wall and a second end wall. The first end wall may be connected to the first end, and the second end wall may be connected to the second end. The support member may be integrally formed within the fairing interior and extend between the first end wall and the second end wall.

The support member may be a front support member, and the fairing may further include a rear support member integrally formed within the fairing interior and extending between the first end wall and the second end wall. The front support member and the rear support member may be connected with a plurality of brace members. The support member may include a first end and a second end. The first end may be integrally formed with the first end wall, and the second end may be integrally formed with the second end wall. The fairing may further include a first external bracket and a second external bracket. The fairing may be configured to be attached to the surface of the trailer such that the first end of the fairing is between the first external bracket and the surface, and the second end of the fairing is between the second external bracket and the surface.

In other aspects, a fairing may be configured to be mounted to a surface of a trailer. The fairing may include a first end, a second end, a main portion extending therebetween, and a flexible attachment member. The main portion may define a fairing interior and include a first end wall and a second end wall. The first end wall may be connected to the first end, and the second end wall may be connected to the second end. The flexible attachment member may be within the fairing interior and may be connected to and extend between the first end wall and the second end wall.

The flexible attachment member may be connected to the first end wall via a first attachment bracket, and may be connected to the second end wall via a second attachment bracket. The fairing may further include a first external bracket and a second external bracket. The first external bracket may be attached to the first end wall of the fairing such that the first end wall is between the first external bracket and the first attachment bracket. The second external bracket may be attached to the second end wall of the fairing such that the second end wall is between the second external bracket and the second attachment bracket. The fairing may be configured to be attached to the surface of the trailer such that the first end of the fairing is between the first external bracket and the surface, and the second end of the fairing is between the second external bracket and the surface. The flexible attachment member may include a first loop that loops around the first attachment bracket and a second loop that loops around the second attachment bracket. The first attachment bracket may include a first cavity that retains a first end of the attachment member. The second attachment bracket may include a second cavity that retains a second end of the attachment member. The flexible attachment member may be a strap, a cable, a wire, or a rope. The fairing may further include a first external bracket and a second external bracket. The fairing may be configured to be attached to the surface such that the first end of the fairing is between the first external bracket and the surface, and the second end of the fairing is between the second external bracket and the surface.

In other aspects, a fairing may be configured to be mounted to a surface of a trailer. The fairing may include a right end, a left end, a main portion extending therebetween, a support member, and a flexible attachment member. The main portion may define a fairing interior and include a right end wall and a left end wall. The right end wall may be connected to the right end, and the left end wall may be connected to the left end. The support member may be within the fairing interior and extend between the right end wall and the left end wall. The flexible attachment member may be threaded through a passage of the support member and may be connected to and extend between the right end wall and the left end wall.

The support member may include a right opening and a left opening, and the passage extends therebetween. The flexible attachment member may include a first end that extends from the right opening to connected to the right end wall, and a left end that extends from the left opening to connect to the left end wall. The fairing may further include a right attachment bracket and a left attachment bracket. The right attachment bracket may connect a first end of the flexible attachment member to the right end wall, and the left attachment bracket may connect a second end of the flexible attachment member to the left end wall. The first end of the flexible attachment member may include a first loop that loops around the right attachment bracket. The second end of the flexible attachment member may include a second loop that loops around the left attachment bracket. The first end of the flexible attachment member may be retained in a right cavity within the right attachment bracket, and the second end of the flexible attachment member may be retained in a left cavity within the left attachment bracket. The support member may be a front support member integrally formed within the fairing interior. The fairing may further include a rear support member integrally formed within the fairing interior. The support member may include a right end that is integrally formed within the right end wall, and a second end that is integrally formed with the left end wall.

In other aspects, an apparatus for a trailer may include a top fairing body, a right external bracket, a left external bracket, a right attachment bracket, a left attachment bracket, and a flexible attachment member. The top fairing body may have an upper surface and a lower surface. The top fairing body may be mounted to a top surface of the trailer. The trailer may have a longitudinal direction, a lateral direction, and a vertical direction. The top fairing body may be located closer to the back of the trailer than to the front of the trailer in the longitudinal direction. The right external bracket and the left external bracket may be attached to the trailer. The right attachment bracket may be attached to the right external bracket. The left attachment bracket may be attached to the left external bracket. The flexible attachment member may extend from the right attachment bracket to the left attachment bracket.

The top fairing body may have a right end that engages the right external bracket. The right attachment bracket may engage the right end such that the right end is located between the right attachment bracket and the right external bracket. The right attachment bracket may not engage the right external bracket. The top fairing body may have a left end that engages the left external bracket. The left attachment bracket may engage the left end such that the left end is located between the left attachment bracket and the left external bracket. The apparatus may further include a right external bracket bolt and a left external bracket bolt. The right external bracket bolt may extend through the right external bracket and the right end to attach the right external bracket to the trailer. The left external bracket bolt may extend through the left external bracket and the left end to attach the left external bracket to the trailer. The apparatus may further include a right attachment bolt and a left attachment bolt. The right attachment bolt may extend through the right external bracket and the right end to attach the right attachment bracket to the right external bracket. The left attachment bolt may extend through the left external bracket and the left end to attach the left attachment bracket to the left external bracket.

The flexible attachment member may be a strap. The strap may be a nylon strap. The strap may be a textile strap. The strap may be a steel strap. The strap may be a leather strap. The flexible attachment member may be a steel cable. The flexible attachment member may be a wire. The flexible attachment member may be a rope. The flexible attachment member may not be under tension. The flexible attachment member may sag. A first end of the flexible attachment member may loop around the right attachment bracket. A second end of the flexible attachment member may loop around the left attachment bracket. The flexible attachment member may be located between the top fairing body and the top surface of the trailer such that the flexible attachment member is not visible from a person standing on ground next to the trailer.

The apparatus may further include a double sided tape that engages the lower surface of the top fairing body and that engages the top surface of the trailer. The double sided tape may function to retain the top fairing body to the trailer. The flexible attachment member may be a secondary mechanism of attachment of the top fairing body to the trailer. The top fairing body may have a support member that provides structural rigidity to the top fairing body. The flexible attachment member may be located between the support member and the upper surface of the top fairing body in the vertical direction. The top fairing body may not extend may not extend rearward of a back end of the trailer in the longitudinal direction. The top fairing body may not have any moving parts during use of the trailer.

### BRIEF DESCRIPTION OF DRAWINGS

FIG. 1 is a side view of a truck hauling a trailer with a fairing located at the rearward end of the trailer at the top of the trailer.

FIG. 2 is a top view of FIG. 1.

FIG. 3 is a close-up side view of the front attachment of the fairing to the top of the trailer.

FIG. 4 is a perspective view of the bottom of the fairing in an assembled condition.

FIG. 5 is an exploded perspective view of the fairing of FIG. 4.

FIG. 6 is a cross-sectional view taken along line 6-6 of FIG. 1.

FIG. 7 is a close-up perspective view of the right end of the fairing with the flexible attachment strap in position.

FIG. 8 is a close-up perspective view of the right end of the fairing with the flexible attachment strap and right attachment bracket in exploded view from the top fairing body.

FIG. 9 is a cross-sectional view taken along the same line as that described above with respect to FIG. 6, but with an alternate arrangement of the flexible attachment member.

The use of identical or similar reference numerals in different figures denotes identical or similar features.

Before any exemplary configurations of the disclosure are explained in detail, it is to be understood that the disclosure is not limited in its application to the details of construction and the arrangement of components set forth in the following description or illustrated in the accompanying drawings. The disclosure is capable of other configurations and of being practiced or of being carried out in various ways. Also, it is to be understood that the phraseology and terminology used herein is for the purpose of description and should not be regarded as limiting.

### DETAILED DESCRIPTION

Reference will now be made in detail to embodiments of this disclosure, one or more examples of which are illustrated in the drawings. Each example is provided by way of explanation of this disclosure, and not meant as a limitation. For example, features illustrated or described as part of one embodiment can be used with another embodiment to yield still a third embodiment. It is intended that the present disclosure include these and other modifications and variations.

The present disclosure provides for a top fairing 14 that improves aerodynamic performance of the trailer 12 to reduce drag on the trailer 12 when a truck 10 is transporting the trailer 12. The top fairing 14 includes a top fairing body 24 having a right end 44 (i.e., a first end), a left end 46 (i.e., a second end), and a main portion 25 extending therebetween. The main portion 25 defines a fairing interior 27 and includes a right end wall 74 (i.e., a first end wall), which is connected to the right end 44, and a left end wall 78 (i.e., a second end wall), which is connected to the left end 46. The top fairing 14 is attached to the top surface 16 of the trailer 12 and features a flexible attachment member 42 within the fairing interior 27 that functions to retain the main portion 25 of the top fairing 14 to the trailer 12 via connection to the right end 44 and the left end 46 of the top fairing 14. The flexible attachment member 42 could be a nylon strap, a textile strap, a leather strap, a steel strap, a wire, a rope, a steel cable, or other type of member. Right and left external brackets 34, 36 (i.e., first and second eternal brackets) rigidly attach the right and left ends 44, 46 of the top fairing body 24 to the trailer 12, and first and second ends 56, 58 of the flexible attachment member 42 are respectively attached to these brackets 34, 36 via a pair of attachment brackets 38, 40. The flexible attachment member 42 could be contained within the fairing interior 27 of the top fairing body 24 and not be visible from the outside of the top fairing 14, such as by a person standing on the ground next to the trailer 12.

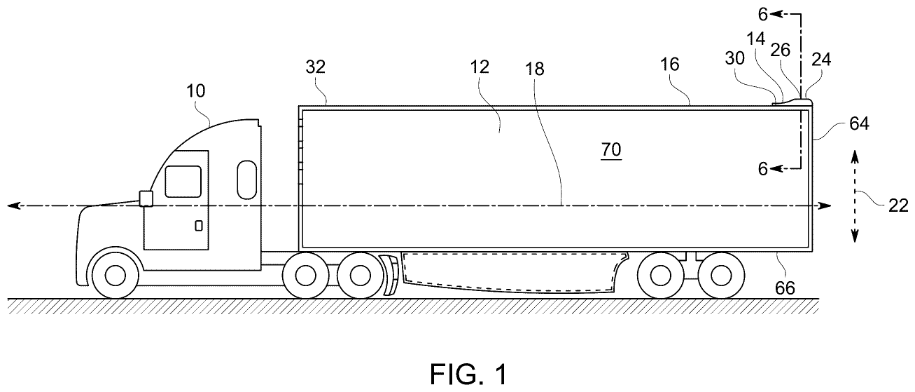

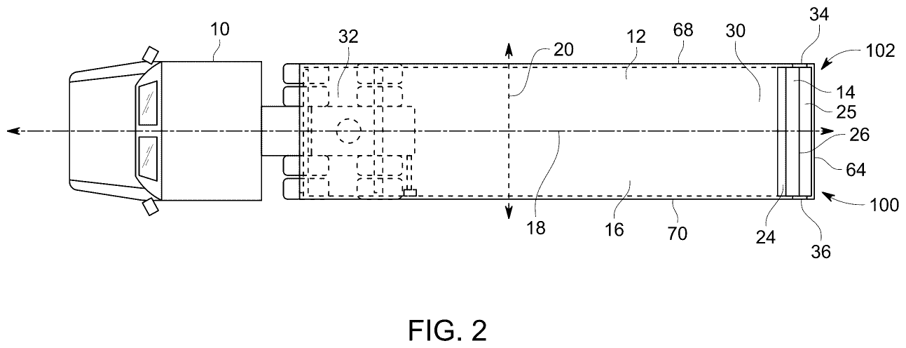

FIGS. 1 and 2 illustrate a truck 10 transporting a trailer 12 that features the top fairing 14 in accordance with one exemplary embodiment. The truck 10 and trailer 12 combination extends in a longitudinal direction 18 of the trailer 12 which is the general direction of travel as the truck 10 pulls the trailer 12 forward. The top fairing 14 directs airflow around the back 30 of the trailer 12 so that drag on the trailer 12 during travel is reduced. The geometric design of the top fairing 14 includes features that result in this reduction of drag. The trailer 12 has a front 32 and a back 30 in relation to the longitudinal direction 18, and the top fairing 14 is located closer to the back 30 than to the front 32 in the longitudinal direction 18. The trailer 12 has a back end 64 which is the back terminal end of the trailer 12 and is the point of the trailer 12 farthest rearward in the longitudinal direction 18. The top fairing 14 does not extend rearward of the back end 64 in the longitudinal direction 18, although the top fairing 14 could extend to the back end 64 or could be located completely forward of the back end 64 in the longitudinal direction 18. In some instances the top fairing 14 could in fact extend rearward of the back end 64 in the longitudinal direction 18. The top fairing 14 is located at the back 30 of the trailer 12 to effect the flow of air at the back 30 of the trailer 12 and behind the trailer 12 during travel. Additional fairings can be employed at the bottom 66 of the trailer 12 or in other locations on the trailer 12 as desired. For example, side fairings could be placed onto the right and left side surfaces 68, 70 of the trailer 12 at the back 30. The top fairing 14 may extend all the way across the top surface 16 in the lateral direction 20 of the trailer 12 so as to be located at both the right and left side surfaces 68, 70. Alternatively, the top fairing 14 may be spaced inboard from one or both of the side surfaces 68, 70. The top fairing body 24 has an upper surface 26 over which air flows as the trailer 12 moves, and the shape of the upper surface 26 is designed to allow for the air to flow over it in a manner that reduces aerodynamic drag on the trailer 12.

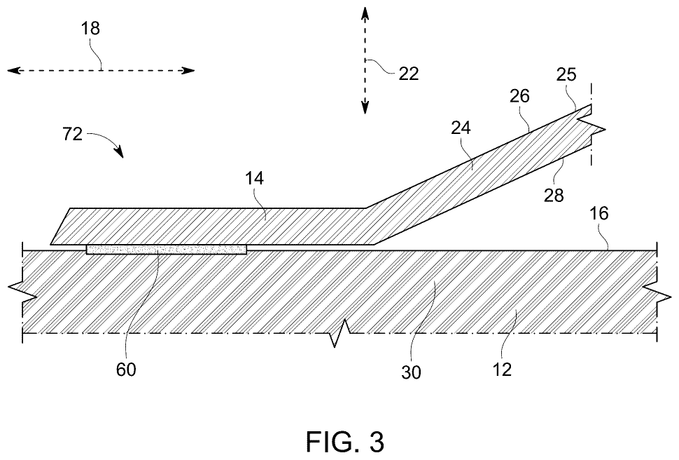

FIG. 3 is a side view of the top fairing 14 and shows the front end 72 of the top fairing 14 in the longitudinal direction 18. The top fairing 14 is attached to the top surface 16 of the trailer 12 via double sided tape 60 that is attached to the top surface 16 and to a lower surface 28 of the top fairing body 24. The double sided tape 60 functions as the primary mechanism of attachment of the main portion 25 of the top fairing 14 to the trailer 12. The double sided tape 60 may extend along a majority of the length of the top fairing 14 in the lateral direction 20. Although the primary mechanism of attachment of the main portion 25 of the top fairing 14 is described as being made through double sided tape 60, other primary mechanisms of attachment are possible such as screws, clamps, single sided tape, adhesives, or mechanical fasteners. Should the primary mechanism of attachment fail, a secondary mechanism of attachment can be provided that functions to retain the main portion 25 of the top fairing 14 to the trailer 12 either in the same position or in a similar position as would be the case when the primary mechanism of attachment was functioning. This secondary mechanism of attachment can be made with the flexible attachment member 42. However, it is to be understood that the flexible attachment member 42 could be the primary and/or only mechanism of attachment of the main portion 25 of the top fairing 14 to the trailer 12 in other embodiments.

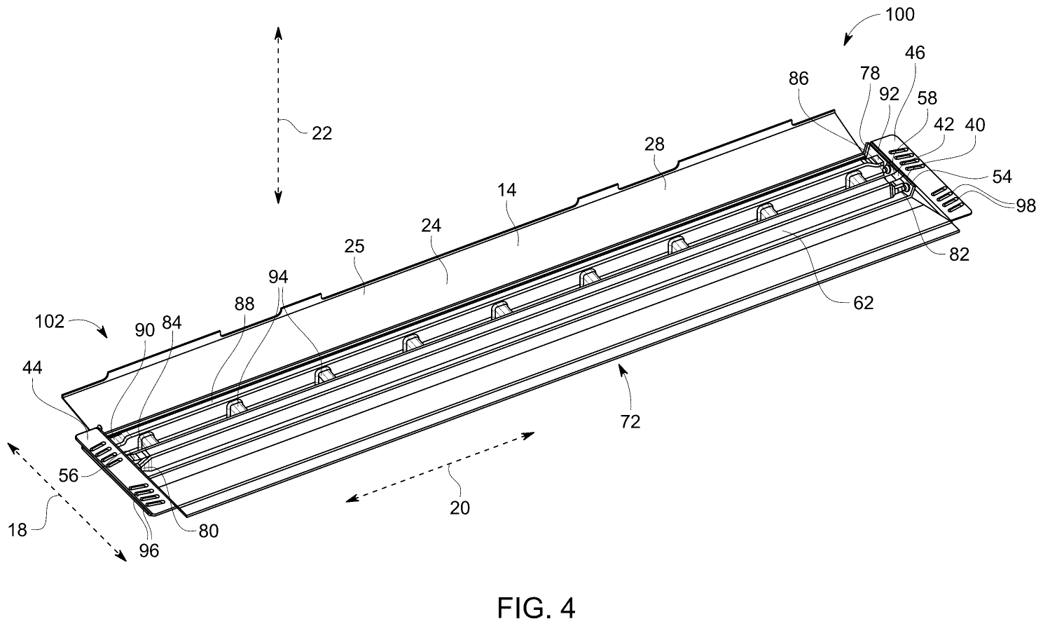

FIG. 4 is a bottom perspective view of the top fairing 14 in accordance with one exemplary embodiment. The top fairing body 24 may be made of a single component or any number of components. The top fairing body 24 has a front support member 62 that extends across the majority of the length of the top fairing body 24 in the lateral direction 20. In some implementations, the top fairing body 24 may further include a rear support member 88 that extends across the majority of the length of the top fairing body 24 in the lateral direction 20. The front support member 62 and the rear support member 88, which are integrally formed within the fairing interior 27 via thermoforming, thus forming a one-piece, monolithic top fairing body 24, add strength to the top fairing body 24, and nine additional features, in the form of a plurality of brace members 94, as shown in FIG. 4, that connect the front support member 62 and the rear support member 88, likewise add strength to the top fairing body 24. The front support member 62 may include a portion of the lower surface 28 of the top fairing body 24 and include a right end 80 (i.e., a first end) and a left end 82 (i.e., a second end). To strengthen the main portion 25 of the top fairing body 24 and minimize potential of the main portion 25 tearing away from the right end 44 and/or the left end 46 of the top fairing body 24, the right end 80 of the front support member 62 may be integrally formed with (e.g., via thermoforming) the right end wall 74 of the main portion 25, and the left end 82 of the front support member 62 may be integrally formed (e.g., via thermoforming) with the left end wall 78 of the main portion 25. The rear support member 88 may include a portion of the lower surface 28 of the top fairing body and include a right end 90 and a left end 92. To strengthen the main portion 25 of the top fairing body 24 and minimize potential of the main portion 25 tearing away from the right end 44 and/or the left end 46 of the top fairing body 24, the right end 90 of the rear support member 88 may be integrally formed (e.g., via thermoforming) with the right end wall 74 of the main portion 25, and the left end 92 of the rear support member 88 may be integrally formed (e.g., via thermoforming) with the left end wall 78 of the main portion 25.

The right end 44 and the left end 46 of the top fairing body 24, which are positioned on opposite ends of the top fairing body 24 in the lateral direction 20, each have a series of slots 96, 98 that are sequential to one another in the longitudinal direction 18. The flexible attachment member 42 is present in the top fairing 14 and is for the most part hidden from view by the front support member 62. In particular, the flexible attachment member 42 is threaded through a passage 87 within the front support member 62. The first and second ends 56, 58 of the flexible attachment member 42 respectively extend through right and left openings 84, 86 of the passage 87 and are visible in FIG. 4 while the rest of the flexible attachment member 42 is contained within the passage 87 of the front support member 62 such that the lower surface 28 at the front support member 62 is between the flexible attachment member 42 and the top surface 16 of the trailer 12 when the top fairing 14 is attached.

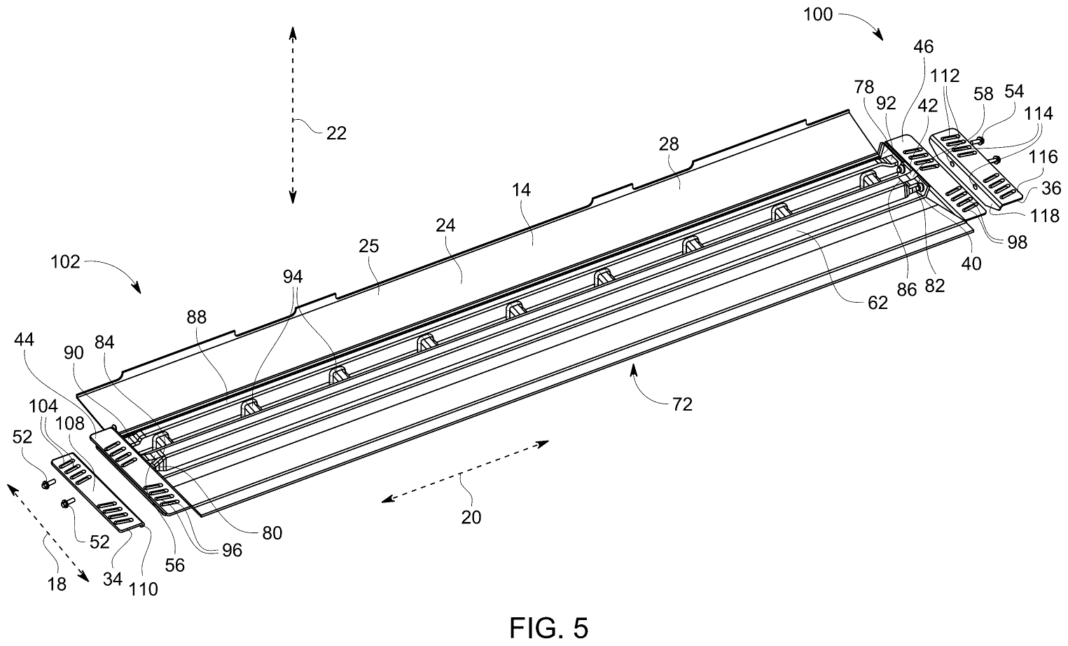

FIG. 5 is the view of the top fairing 14 of FIG. 4 but with the right external bracket 34 and the left external bracket 36 in exploded view. The flexible attachment member 42 in this embodiment is a strap that may not be under tension. Instead, the flexible attachment member 42 may have some amount of sag in it in that it bows at some point along its length in the lateral direction 20. This sag is opposite to what the flexible attachment member 42 would look like if it were in tension and pulled tight from the first end 56 to the second end 58. As such, embodiments of the top fairing 14 exist in which the flexible attachment member 42 has some amount of slack. The right and left external brackets 34, 36 may not be part of the top fairing body 24 but may be separate components. The illustrated exemplary brackets 34, 36 have a general L-shape cross-section and feature slots 104, 112 and apertures 106, 114. In particular, the right external bracket 34 includes panels 108, 110 that form the general L-shape cross-section. The panel 108 includes the slots 104, and the panel 110 includes the apertures 106. Likewise, the left external bracket 36 includes panels 116, 118 that form the general L-shape cross-section. The panel 116 includes the slots 112, and the panel 118 includes the apertures 114. Right and left attachment bolts 52, 54 are present and are shown. The right attachment bolts 52 extend through the apertures 106 of the right external bracket 34 and apertures 76 of the right end wall 74 to attach the right external bracket 34 to the right end 44. The left attachment bolts 54 extend through the apertures 114 in the left external bracket 36 and apertures (not shown) in the left end wall 78 to attach the left external bracket 36 to the left end 46. Although two right attachment bolts 52 and two left attachment bolts 54 are present, there may be only a single right attachment bolt 52 and a single left attachment bolt 54 in other embodiments. In yet other configurations, any number of left and right attachment bolts 54, 52 can be present in the apparatus.

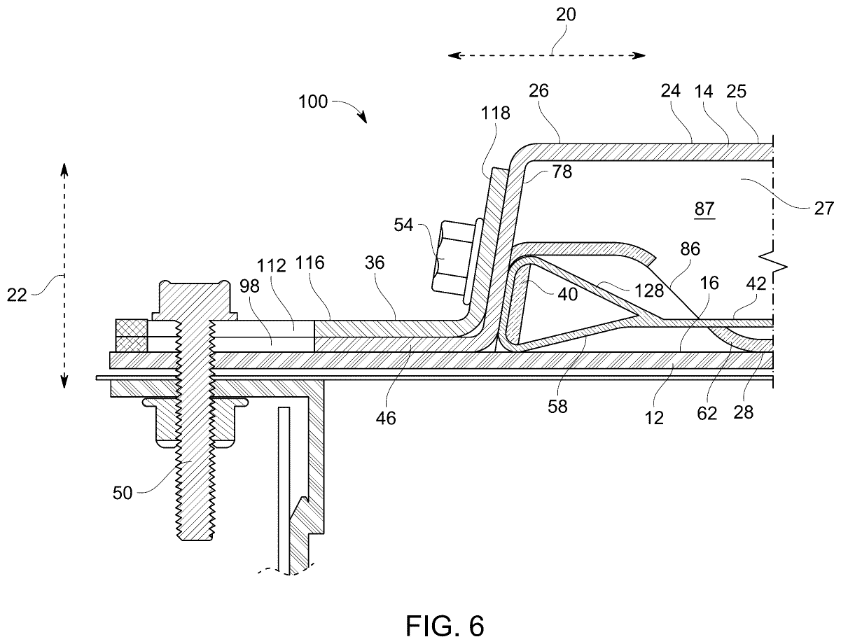

FIG. 6 is a cross-sectional view that shows a left side 100 of the top fairing 14 as attached to the trailer 12. The left end 46 engages the top surface 16, and the left external bracket 36 is located on and engages the left end 46. The left and right ends 46, 44 can be integrally formed (e.g., via thermoforming) with the top fairing body 24, the front support member 62, and the rear support member 88 so that they are all a single piece, monolithic component. However, in some implementations, the left and right ends 46, 44, the front support member 62, and/or the rear support member 88 may be different components that are attached to one another in other embodiments. The slots 98, 112 of the left end 46 and the left external bracket 36 are aligned with one another, and a left external bracket bolt 50 extends through these aligned slots 98, 112 so as to extend through the left end 46 and the left external bracket 36. Tightening of the left external bracket bolt 50 causes the left external bracket 36 and the left end 46 to be attached to the trailer 12. The left end 46 is located between the left external bracket 36 and the top surface 16. Although a single left external bracket bolt 50 is shown, any number of left external bracket bolts 50 can be used in other embodiments to effect this attachment. Although not shown in FIG. 6, a similar right external bracket 34 is attached to the trailer 12 via one or more right external bracket bolts 48 extending through the slots 96 of the right external bracket 34 and the slots 104 of the right end 44 to cause the right external bracket 34 and the right end 44 to be attached to the trailer 12. The right end 44 is located between the right external bracket 34 and the top surface 16. The left and right external bracket bolts 50, 48 may thus cause the left and right ends 46, 44 of the top fairing body 24 to be retained onto the top surface 16.

The flexible attachment member 42 is a strap that is looped to form a loop 126 at the first end 56 and is likewise looped to form a loop 128 at the second end 58 which is shown in FIG. 6. The left attachment bracket 40 (i.e., second attachment bracket) is positioned so that it extends through the loop 128 of the second end 58. A pair of left attachment bolts 54 extend through the apertures 114 in the left external bracket 36, the apertures (not shown) in the left end wall 78, and apertures 124 in the left attachment bracket 40. Tightening of the left attachment bolts 54 causes the left attachment bracket 40 to be attached to the left external bracket 36 and for the left end 46 to again be attached to the left external bracket 36. The second end 58 of the flexible attachment member 42 is thus indirectly attached to the left external bracket 36. Tightening of the left attachment bolts 54 causes the second end 58 of the flexible attachment member 42 to be secured by being squeezed between the left attachment bracket 40 and the left end wall 78 so that the flexible attachment member 42 is restrained against forward or rearward movement in the longitudinal direction 18.

The opposite side of the top fairing 14 is arranged in a similar manner. The first end 56, which is formed into the loop 126, is located between the right attachment bracket 38 (i.e., first attachment bracket) and the right end 44 and is secured via the right attachment bolts 52. The right attachment bolts 52 extend through the apertures 120 of the right attachment bracket 38, the apertures 76 of the right end wall 74, and the apertures 106 of the right external bracket 34, and in this regard the first end 56 of the flexible attachment member 42 is indirectly attached to the right external bracket 34. The right components of the top fairing 14 can all be arranged in a similar manner to the left components as previously discussed and a repeat of this information is not necessary. The loops 126, 128 at the first end 56 and second end 58 are made by sewing, mechanical fasteners, integral formation, or other mechanisms. The flexible attachment member 42 extends from the first and second ends 56, 58 and since each end 56, 58 is indirectly attached to the external brackets 34, 36, in the design the flexible attachment member 42 is attached to the trailer 12 by way of the external brackets 34, 36.

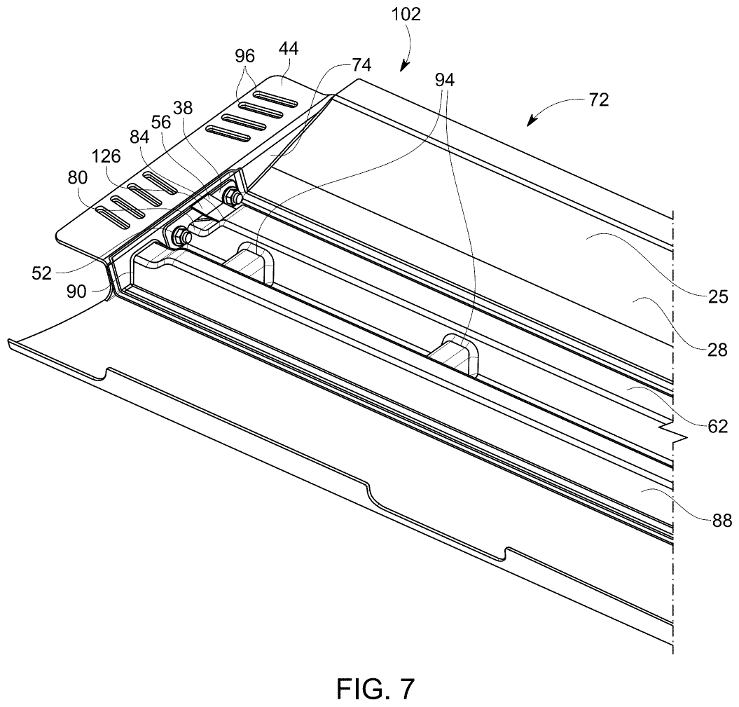

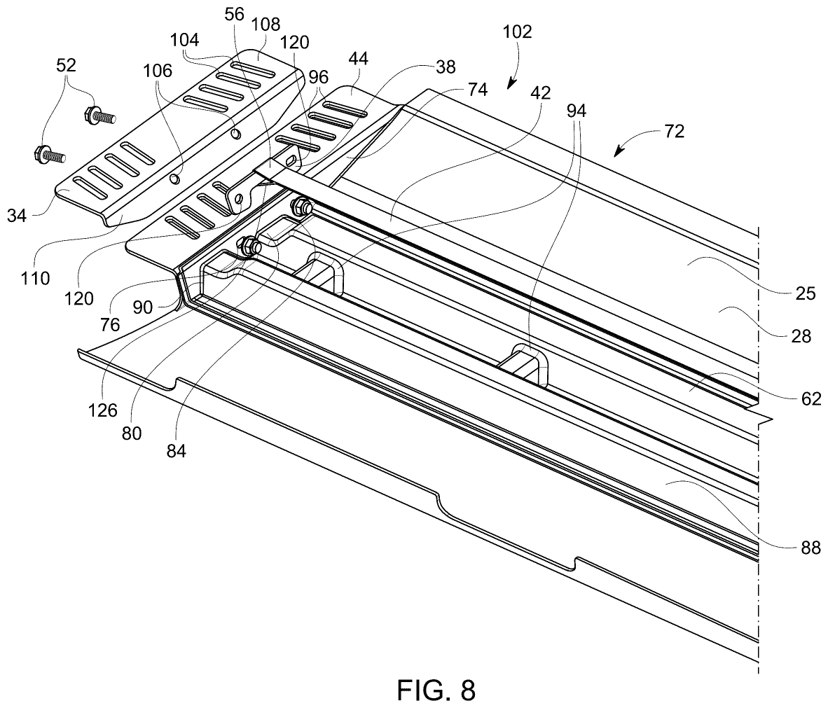

FIGS. 7 and 8 show the right end 102 of the top fairing 14 in an assembled view and an exploded view, respectively. The illustrated exemplary top fairing body 24 is a single piece component such that the left and right ends 44, 46 are all formed as a single piece with the front support member 62, the rear support member 88, and the rest of the top fairing body 24. In other configurations the top fairing body 24 may be formed from multiple pieces. In FIG. 8, the right external bracket 34 is shown removed from the right end 44 and a pair of right attachment bolts 52 are likewise removed. Although two right attachment bolts 52 are used to secure the right external bracket 34, the right end 44, and the right attachment bracket 38, any number of right attachment bolts 52 could be used in other embodiments. FIG. 8 shows the flexible attachment member 42 in an exploded position, and FIG. 7 shows the flexible attachment member 42 within the front support member 62 as would be the case when assembled during use of the top fairing 14. The first end 56 of the flexible attachment member 42 extends from the right opening 84 of the passage 87 of the front support member 62 and is thus not within the front support member 62. However, the length of the flexible attachment member 42 between the first and second ends 56, 58 is within the passage 87 of the front support member 62. If the primary attachment mechanism of the top fairing 14 were to fail, the main portion 25 of top fairing body 24 would be retained onto the trailer 12 because the flexible attachment member 42 is attached to the external brackets 34, 36 and is within the front support member 62. The portions of the top fairing body 24 that are between the flexible attachment member 42 and the top surface 16 in the vertical direction 22 are caught by the flexible attachment member 42 to cause the entire top fairing body 24 to be retained to the trailer 12. The portions of the top fairing body 24 that are forward and rearward of the flexible attachment member 42 in the longitudinal direction 18 will engage the flexible attachment member 42 to likewise cause the top fairing body 24 to be retained to the trailer 12. In other words, because the flexible attachment member 42 is threaded through the passage 87 of the front support member 62, which is a component of the main portion 25, the flexible attachment member 42 is configured to limit vertical displacement of the main portion 25 and thus prevent the main portion 25 from tearing away from the right and left ends 44, 46 in the event that the double sided tape 60 fails.

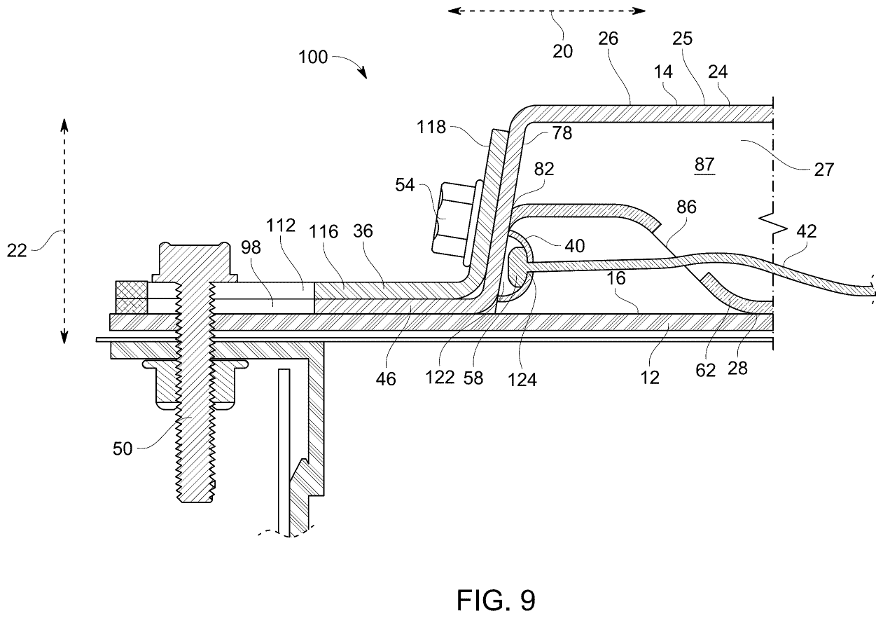

FIG. 9 is an alternate embodiment of the top fairing 14 as attached to the trailer 12 and as shown in cross-sectional view along the same cross-sectional line as that shown in FIG. 6. The top fairing 14 differs in that the flexible attachment member 42 is not a strap and does not have loops at its first end 56 and second end 58. Instead, the flexible attachment member 42 is a steel cable, rope or wire. The flexible attachment member 42 may have some degree of sag or slack in it, and may not be pulled completely into a state of tension between the right and left attachment brackets 38 and 40. The left attachment bracket 40 can define a cavity 122 into which the second end 58 is located and is of a size that is too small for the second end 58 to be pulled from an opening of the left attachment bracket 40 that leads into the cavity. The second end 58 can thus be retained by the left attachment bracket 40 and attached to the left external bracket 36. The first end 56 may be configured with the right attachment bracket 38 in a similar manner such that the first end 56 has a size that prevents it from leaving the opening (not shown) of the right attachment bracket 38 that extends into the cavity (not shown) of the right attachment bracket 38. It is to be understood that the mechanisms of attaching the first and second ends 56, 58 to the right and left attachment brackets 38, 40 are varied in possibility and that others besides those disclosed are possible.

The flexible attachment member 42 can provide a secondary mechanism of securement of the main portion 25 of the top fairing 14 to the trailer 12 should the primary mechanism of attachment, such as the double sided tape 60 attachment, fail. In this regard, the flexible attachment member 42 will still retain the main portion 25 of the top fairing 14 to the trailer 12 even if main portion 25 of the top fairing 14 becomes detached from the double sided tape 60. Alternatively, the flexible attachment member 42 can be provided as the primary mechanism of attachment of the main portion 25 of the top fairing 14 to the trailer 12 in some embodiments, and in these embodiments a secondary mechanism of attachment is not present. The arrangement of the flexible attachment member 42 contemplates right and left external brackets 34, 36 that are rigidly attached to the trailer 12, with the flexible attachment member 42 in turn attached to these external brackets 34, 36 with the top fairing body 24 captured by the flexible attachment member 42 through its geometry and retained to the top surface 16.

The flexible attachment member 42 can be a metallic component, or can be a non-metallic component. The flexible attachment member 42 is flexible in that it can bend or sag along its length in the lateral direction 20 as positioned in the top fairing 14. The placement of the top fairing body 24 onto the top surface 16 with the flexible attachment member 42 within the space defined by the top fairing body 24 and the top surface 16 (e.g., the fairing interior 27) causes the flexible attachment member 42 to be contained within and not visible by an observer on the ground next to the trailer 12. In this regard, the ends 56, 58 of the flexible attachment member 42 are contained within the fairing interior 27 and are not visible from outside of the top fairing body 24 and do not directly engage the external brackets 34, 36. Placement of the flexible attachment member 42 within the top fairing body 24 reduces exposure of the flexible attachment member 42 to environmental damage since it is shielded from the elements. The flexible attachment member 42 generally does not add appreciable structural integrity to the top fairing 14 and generally does not function appreciably to support or stiffen the top fairing 14. Instead, portions of the top fairing body 24 such as the front support member 62, the rear support member 88, and the plurality of brace members 94 are designed to provide structural integrity to the top fairing 14 and stiffen and support this assembly.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

As uses herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A fairing that is configured to be mounted to a surface of a trailer, the fairing comprising:
a first end;
a second end;
a main portion extending between the first end and the second end and defining a fairing interior, the main portion comprising:
a first end wall connected to the first end, and
a second end wall connected to the second end; and
a support member integrally formed within the fairing interior and extending between the first end wall and the second end wall.

2. The fairing of claim 1, wherein the support member is a front support member; and
the fairing further comprises:
a rear support member integrally formed within the fairing interior and extending between the first end wall and the second end wall.

3. The fairing of claim 2, wherein the front support member and the rear support member are connected with a plurality of brace members.

4. The fairing of claim 1, wherein the support member includes:
a first end that is integrally formed with the first end wall, and
a second end that is integrally formed with the second end wall.

5. The fairing of claim 1, wherein the main portion defines a front end of the fairing that is connected to double-sided tape for attachment to the surface of the trailer.

6. The fairing of claim 1, further comprising:
a first external bracket; and
a second external bracket;
wherein the fairing is configured to be attached to the surface of the trailer such that:
the first end of the fairing is between the first external bracket and the surface, and the second end of the fairing is between the second external bracket and the surface.

7. A fairing that is configured to be mounted to a surface of a trailer, the fairing comprising:
a first end;
a second end;
a main portion extending between the first end and the second end and defining a fairing interior, the main portion comprising:
a first end wall connected to the first end, and
a second end wall connected to the second end; and
a flexible attachment member within the fairing interior and connected to and extending between the first end wall and the second end wall.

8. The fairing of claim 7, wherein the flexible attachment member is connected to the first end wall via a first attachment bracket; and
wherein the flexible attachment member is connected to the second end wall via a second attachment bracket.

9. The fairing of claim 8, further comprising:
a first external bracket attached to the first end wall of the fairing such that the first end wall is between the first external bracket and the first attachment bracket; and
a second external bracket attached to the second end wall of the fairing such that the second end wall is between the second external bracket and the second attachment bracket;
wherein the fairing is configured to be attached to the surface of the trailer such that:
the first end of the fairing is between the first external bracket and the surface, and
the second end of the fairing is between the second external bracket and the surface.

10. The fairing of claim 8, wherein the flexible attachment member includes:
a first loop that loops around the first attachment bracket; and
a second loop that loops around the second attachment bracket.

11. The fairing of claim 8, wherein the first attachment bracket includes a first cavity that retains a first end of the attachment member; and
wherein the second attachment bracket includes a second cavity that retains a second end of the attachment member.

12. The fairing of claim 7, wherein the flexible attachment member is at least one of a strap, a cable, a wire, or a rope.

13. The fairing of claim 7, further comprising:
a first external bracket; and
a second external bracket;
wherein the fairing is configured to be attached to the surface such that:
the first end of the fairing is between the first external bracket and the surface, and
the second end of the fairing is between the second external bracket and the surface.

14. A fairing that is configured to be mounted to a surface of a trailer, the fairing comprising:
a right end;
a left end;
a main portion extending between the right end and the left end and defining a fairing interior, the main portion comprising:
a right end wall connected to the right end, and
a left end wall connected to the left end;
a support member within the fairing interior and extending between the right end wall and the left end wall; and
a flexible attachment member threaded through a passage of the support member and connected to and extending between the right end wall and the left end wall.

15. The fairing of claim 14, wherein the support member includes a right opening and a left opening, and the passage extends therebetween; and
wherein the flexible attachment member includes:
a first end that extends from the right opening to connect to the right end wall, and
a left end that extends from the left opening to connect to the left end wall.

16. The fairing of claim 14, further comprising:
a right attachment bracket that connects a first end of the flexible attachment member to the right end wall; and
a left attachment bracket that connects a second end of the flexible attachment member to the left end wall.

17. The fairing of claim 16, wherein the first end of the flexible attachment member includes a first loop that loops around the right attachment bracket; and
wherein the second end of the flexible attachment member includes a second loop that loops around the left attachment bracket.

18. The fairing of claim 16, wherein the first end of the flexible attachment member is retained in a right cavity within the right attachment bracket; and
wherein the second end of the flexible attachment member is retained in a second cavity within the left attachment bracket.

19. The fairing of claim 14, wherein the support member is a front support member integrally formed within the fairing interior; and
wherein the fairing further includes a rear support member integrally formed within the fairing interior.

20. The fairing of claim 14, wherein the support member includes:
a right end that is integrally formed with the right end wall; and
a second end that is integrally formed with the left end wall.
